(19) United States
(12) Patent Application Publication
(10) Pub. No.: US 2020/0288687 A1
(43) Pub. Date: Sep. 17, 2020

(54) Repositionable Removable Fishing Hook Trailer Device

(71) Applicant: CLAM CORPORATIOn, Rogers, MN (US)

(72) Inventor: James P. Schaubach, Virginia City, NV (US)

(21) Appl. No.: 16/432,654

(22) Filed: Jun. 5, 2019

Related U.S. Application Data
(60) Provisional application No. 62/817,678, filed on Mar. 13, 2019.

(51) Int. Cl. A01K 85/16; A01K 83/00; A01K 91/03

(52) U.S. Cl. CPC A01K 85/16; A01K 91/065; A01K 91/03; A01K 83/00

(57) ABSTRACT

A repositionable removable fishing hook trailer device for use on a fishing hook includes a body, wherein the body includes a resilient elastomeric bead. The device further includes a plurality of tendrils having a portion received in a first passage through the body and at least one portion extending outward from the body, and the body is further configured to receive a portion of a fishing hook within a second passage through the body.

### CROSS-REFERENCE TO RELATED APPLICATION

This application claims the benefit of priority of U.S. Provisional Patent Application Ser. No. 62/817,678, filed Mar. 13, 2019, the disclosure of which is hereby incorporated by reference in its entirety.

### BACKGROUND OF THE INVENTION

### Field of the Invention

The present invention generally relates to fishing equipment, such as tackle or lures, and more particularly to accessories to be connected to a fishing hook or to a hook on a fishing lure or rig.

### Discussion of the Prior Art

There are a variety of devices used to attract fish. Most are built into lure configurations that are intended to be connected to a fishing line and used for open water fishing and ice fishing. Some of the lure devices include a structure generally referred to as a weed guard or skirt that is formed of plastic, buck tail hair or the like. The structures generally do not serve as a bait, and they are intended to have sufficient rigidity to help protect a hook on the lure from snagging a weed. Such devices may be integrated into the design and structure of the lure or added as an accessory after constructing the lure.

### SUMMARY OF THE INVENTION

The purpose and advantages of the invention will be set forth in and apparent from the description and drawings that follow, as well as will be learned by practice of the claimed subject matter.

This disclosure generally provides a repositionable removable fishing hook trailer device having advantageous features that permit new ways of presenting a fish a device that may serve as an attractant or bait. The present disclosure presents devices that are accessories to be connected to an independent fishing hook or to a fishing hook on a fishing lure, rig or the like. The devices may be used for open water fishing, such as for use when casting, trolling or with a bobber, as well as for use when ice fishing.

The devices are in the form of repositionable removable trailer devices for use on fishing hooks, in the sense that they may be connected to and readily repositioned on a fishing hook and they provide a wispy, flowing, trailing portion. The devices include a body made of a resilient elastomeric material and a plurality of tendrils, such as threads, that extend through the body.

The body originally may be solid and may be punctured to pass the tendrils therethrough, thereby forming a passage. Similarly, the original solid body may be punctured when applied to an independent fishing hook or to a fishing hook of a fishing lure, rig or the like. Alternatively, the body may be formed or modified to have one or more preformed passages therethrough. For example, a body may include a passage for receiving and retaining the tendrils and/or may include a passage for receiving and being retained on a fishing hook, and it will be appreciated that the tendrils and fishing hook may share one passage. In any of these configurations, the inherent resistance to expand causes compression within the resilient elastomeric body, which enables the body to grip the tendrils passing therethrough without the need for additional means to secure the tendrils within the body. The internal compression also will permit the body to be positioned anywhere along the length of a fishing hook and in any desired rotational position relative to the fishing hook, while still permitting the body to be removed from the fishing hook entirely, or to be reconnected to the fishing hook at a different angle.

The compression and friction within the body not only help retain the tendrils but permit the device to be used for numerous fish attracting presentations, based on the direction the tendrils are extending through the body, and the orientation of that direction relative to the orientation of the portion of the fishing hook that is passing through the body, as well as the location on the fishing hook, ranging from the top of the shaft to the barb of the fishing hook. It will be appreciated that adjusting the location of the passage for the fishing hook relative to the location and rotational position of the body on the fishing hook, may provide a variety of attractive presentations to fish. In addition, a variety of colors and weights of the body and tendrils may be used, which further expands the potential variety of attractive presentations to fish. Indeed, unique mixes of colors may be utilized within the plurality of tendrils, which may create proprietary looks or particularly attractive combinations.

The tendrils are not intended to function as a weed guard. Rather, they are intended to be strong and somewhat durable, yet light enough to flow with the water they absorb, advantageously presenting a novel and nonobvious way to attract fish to a fishing hook to which the body is connected. This preferably is achieved by using silk thread, such as 100 weight pure filament silk or the like. The silk is fine but not fragile and numbers of fish can be caught without replacement. Indeed, after multiple fish biting, inhaling and fighting, resulting in debris, slime and tissue accumulation, while tangling and braiding may occur, the tendrils may be combed to mitigate this.

In a first aspect, this disclosure provides a repositionable removable fishing hook trailer device for use on a fishing hook includes a body, wherein the body includes a resilient elastomeric bead. The device further includes a plurality of tendrils having a portion received in a first passage through the body and at least one portion extending outward from the body, and the body is further configured to receive a portion of a fishing hook within a second passage through the body.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a front view of a first example repositionable removable fishing hook trailer device.

FIG. 2 is a front view of the first example device positioned near the bottom of a hook of a jig lure.

FIG. 3 is a side view of a second example repositionable removable fishing hook trailer device.

FIG. 4 is an upper front perspective view of a third example repositionable removable fishing hook trailer device.

FIG. 5 is an upper front perspective view of a fourth example repositionable removable fishing hook trailer device.

FIG. 6 is a side perspective view of a fifth example repositionable removable fishing hook trailer device.

FIG. 7A is a side perspective view of a sixth example repositionable removable fishing hook trailer device.

FIG. 7B is an end perspective view of the sixth example device.

It should be understood that the figures are not to scale. While some mechanical details of example repositionable removable fishing hook trailer devices, including additional plan and section views of the examples shown and of examples that may have alternative configurations, have not been included, such details are considered well within the comprehension of those of skill in the art in light of the present disclosure. It also should be understood that the present invention is not limited to the example embodiments illustrated.

### DETAILED DESCRIPTION OF THE PREFERRED EMBODIMENTS

For the following defined terms, these definitions shall be applied, unless a different definition is given in the claims or elsewhere in this disclosure. As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise.

Referring generally to FIGS. 1-7B, it will be appreciated that repositionable removable fishing hook trailer devices of the present disclosure generally may be embodied within numerous configurations, and may be used in various ways on fishing hooks to attract fish. Indeed, while acknowledging that all of the example configurations of repositionable removable fishing hook trailer devices need not be shown herein, examples are provided to better demonstrate that a variety of configurations and methods of use are contemplated.

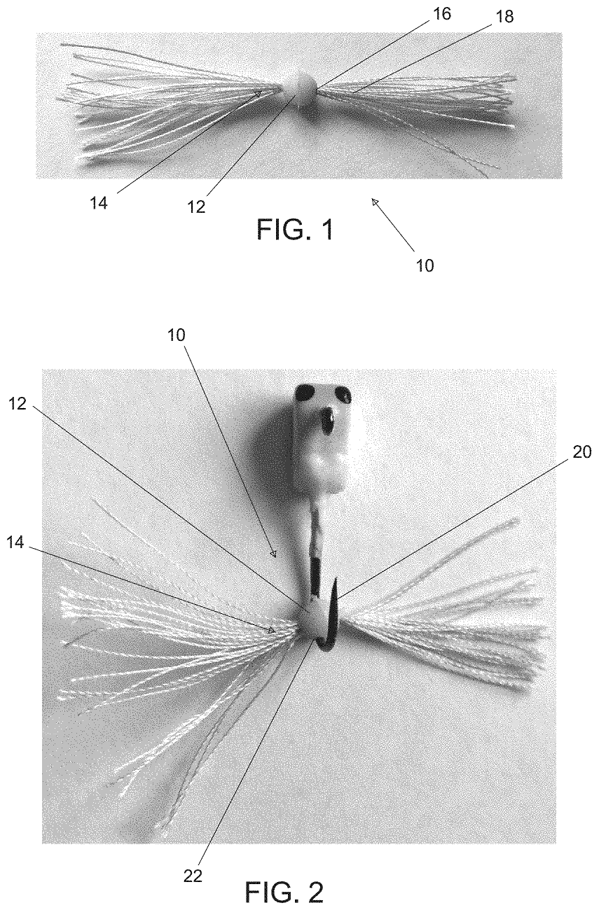

Turning to FIGS. 1 and 2, a first example embodiment of a repositionable removable fishing hook trailer device 10 for use on a fishing hook is shown. As seen in FIG. 1, the device 10 includes a body 12, which is configured as a solid bead. The body 12 of this example is constructed of a resilient elastomeric material, such as silicone, but may be constructed of other suitable resilient elastomeric materials, such as rubber or the like. The device 10 includes a plurality of tendrils 14 having a portion received in a first passage 16 through the body 12 and at least one portion 18 extending outward from the body 12. In this example, the plurality of tendrils 14 extend outward from the body 12 in opposed directions. The body 12 also is configured to receive a portion of a fishing hook 20 within a second passage 22 through the body 12. The first passage 16 may extend through the body 12 in a first direction and the second passage 22 may extend through the body 12 in a second direction. It will be appreciated that the first and second directions may be at virtually any an angle relative to each other, and indeed the first and second passages may be one and the same, such that the first and second directions are identical.

The plurality of tendrils 14 may include, for example a group of twenty tendrils having a portion extending from side-to-side through the first passage 16 and being retained by the body 12. The first passage 16 of this example is formed by forcing the tendrils 14 through the body 12, such as by using a needle. Once the tendrils 14 have been forced to have a portion extend through the body 12 in a first direction, the compression within the body 12 provides sufficient grip to hold the plurality of tendrils 14. The inherent resistance of the body 12 to expand causes compression within the resilient elastomeric body 12. The internal compression and the friction of the material of the body 12 enable the body 12 to grip the portion of the tendrils 14 passing therethrough without the need for additional means to secure the tendrils within the body 12. It will be appreciated that the number, length and weight of the tendrils may vary, and may depend upon the size or weight of the fishing hook, lure, rig or the like with which the device is used. For instance, it has been found that a group of twenty tendrils may be quite effective, but fewer or more tendrils may be used, as desired. Similarly, the length of the tendrils may vary, with ¾ inch to 1 inch providing excellent action, but shorter or longer tendrils, or a mixture of lengths may be used, as desired, as it will be appreciated that the length and weight of the tendrils may impact the drop speed when used for instance for ice fishing.

When in the position of use shown in FIG. 2, a fishing hook 20 similarly extends through a second passage 22 through the body 12. In this example, the second passage 22 extends through the body 12 in a second direction, which is generally perpendicular to the first passage 16. The body 12 may be sized to receive and grip a portion of the fishing hook 20 extending through the second passage the body 12, such as for example being a round bead having a diameter of about ⅛ inch. However, it will be appreciated that other sizes may be used, with considerations for the size of the body 12 including at least the number and thickness of the tendrils 14 and the thickness of the fishing hook 20 that will extend through the body 12, as well as the desired ease of handling of the body 12.

In this first example device 10, the tendrils 14 extend through the first passage 16 through the body 12 in an orientation or configuration that is generally perpendicular to the direction of the fishing hook 20 having a portion that extends through the second passage 22. It will be appreciated that the fishing hook 20 may be used to pierce and be extended through the body 12 in any direction. For instance, a portion of the fishing hook 20 may extend through the body 12 at any angle relative to the first passage 16 for the tendrils 14, or it may pass through the same first passage 16 that receives the portion of the tendrils 14. Thus, the fishing hook 20 may pass through the same first passage as the tendrils or through a separate second passage, whether parallel to, perpendicular to or at some other angle relative to the first passage for the tendrils. It will be appreciated that the body 12 is readily removable from the fishing hook 20 by sliding it off the fishing hook, and the body 12 may be reconnected to the fishing hook 20 by piercing through the previously formed second passage 22 or through a new location to form a new second passage through the body 12 at a different angle.

As previously noted, the body 12 may be constructed of a resilient elastomeric material, which will exert internal compression on anything forced through the body 12. The tendrils 14 preferably are constructed of silk, such as 100 weight pure filament silk thread or the like. The lack of rigidity of the silk, its natural formation and ability to absorb and appear to flow like the water in which it is placed, provide a unique presentation and action. These are important aspects because the device 10 is not intended to have rigidity with respect to acting as a weed guard, but rather is intended to flow and attract fish. Indeed, in some instances, the device may be used alone on a fishing hook as the bait. Also, it may be that other materials may be used for the tendrils, whether of natural or synthetic origin, but tendrils constructed of a material other than silk would need to be structured as a fine thread, fiber, hair, strand or filament and should appear when placed in water to flow with the movement of the water.

As seen in FIG. 2, the tendrils 14 of the fishing hook trailer device 10 will extend from and tend to trail the fishing hook 20 as it moves in water. With the tendrils 14 extending perpendicularly from the sides of the fishing hook 20, the tendrils 14 may appear to resemble wings, such as wings of a large insect, which may be particularly advantageous in attracting fish. It also will be appreciated that the device 10 may be used on a fishing hook alone or multiple devices 10 may be used in a stacked or separated arrangement on the same fishing hook, for still further variations in the presentation to fish.

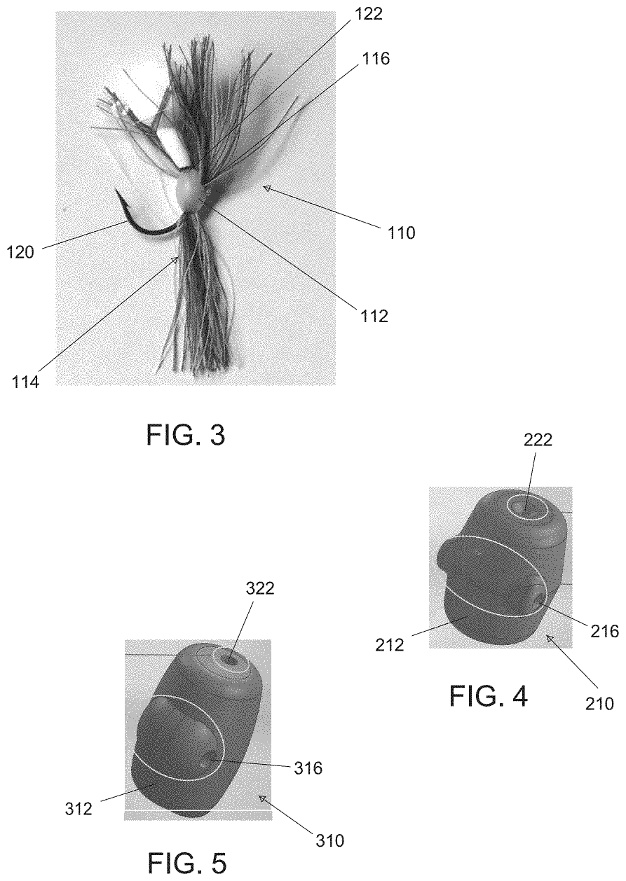

FIG. 3 shows a second example repositionable removable fishing hook trailer device 110 for use on a fishing hook. The device 110 includes a resilient elastomeric body 112 that is configured as a bead and sized to receive and grip a portion of a fishing hook 120. This second example device 110 is shown positioned along the shaft of the fishing hook 120 of a jig lure. In this example, a portion of a plurality of tendrils 114 extend through a first passage 116, with at least a portion of the tendrils 114 extending outward from the body 112. A portion of the fishing hook 120 extends through a second passage 122, which is nearly parallel to the first passage 116. With the tendrils 114 extending through the first passage 116 nearly parallel to a position of the shaft of the fishing hook 120 extending through the second passage 122, the tendrils 114 will tend to trail the fishing hook 120 as it moves through the water and may appear to resemble the tail of an animal, such as a small fish, which may be particularly advantageous in attracting fish.

FIG. 4 shows an alternative body 212 for a third repositionable removable fishing hook trailer device 210 for use on a fishing hook. A portion of a plurality of tendrils (not shown for ease of viewing the body) would extend through a first passage 216 in the body 212. However, unlike the first example, the first passage 216 of this third example device 210 is pre-formed to provide easier insertion of the tendrils. The body 212 is configured to receive a portion of a fishing hook within a second passage 222 through the body 212, and the second passage 222 is pre-formed to provide easier insertion of a fishing hook. In this third example device 210, the first and second passages 216, 222 also are pre-formed to better ensure the entry and exit points of the tendrils and fishing hook, respectively. This may help facilitate removal of the body 212 from a fishing hook. It also will be appreciated that this may be beneficial to ensuring balanced centerline alignment of the body and tendrils relative to the fishing hook on which they are used as they flow through the water, which in turn, may reduce a tendency to twist the fishing line.

The first passage 216 through the body 212 is fairly long relative to the diameter of the body 212, which may help to grip and secure the portion of the plurality of tendrils that would be inserted through the first passage 216. The second passage 222 extends longitudinally and generally through the center of the body 212. As with the prior versions, the resilient elastomeric material of the body 212 enables a user to slide the body 212 onto a fishing hook in any desired position along the fishing hook, as well as to later reposition the body 212 at some other position along the fishing hook. In each instance, the body 212 will hold its position on the portion of the fishing hook that is engaging the body 212. The ability to hold its position may be demonstrated with respect to where along the length of the fishing hook the body 212 is located, as well as with respect to the rotational orientation of the body 212 relative to the fishing hook.

FIG. 5 shows another alternative body 312 for a fourth repositionable removable fishing hook trailer device 310 for use on a fishing hook. The body 312 includes a first passage 316 that is pre-formed to provide easier insertion of a plurality of tendrils (not shown for ease of viewing the body). The body 312 similarly includes a second passage 322 that is pre-formed to provide easier insertion of a fishing hook. As with the third example device 210, the fourth example device 310 has first and second passages 316, 322 that also are pre-formed to better ensure the entry and exit points of the tendrils and fishing hook, which may ease removal, and may be beneficial to ensuring balanced flow through the water of a fishing hook, lure, rig or the like on which the device 310 is used.

The first passage 316 through the body 312 is not quite as long as the first passage 218 in the second example, but it should reduce the length of the portion of the body 312 holding the portion of the tendrils received within the first passage 316, which should expose more of the tendrils and may let the tendrils bend more freely. The second passage 320 is offset relative to the longitudinal center of the body 312. This also may be helpful in balancing a fishing hook, lure, rig or the like to which the device 310 would be connected by ensuring the tendrils will trail the connection to the fishing hook.

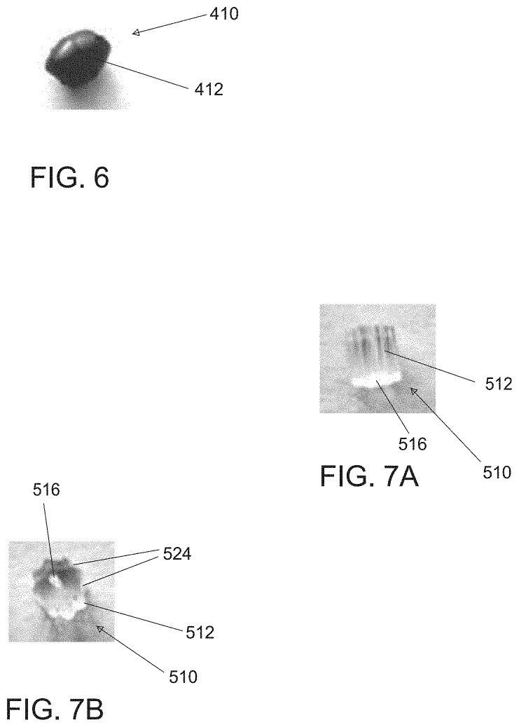

Turning to FIG. 6, a further alternative body 412 for a fifth example repositionable removable fishing hook trailer device 410 for use on a fishing hook is shown. The body 412 is constructed of rubber and provides an alternative that is somewhat similar to the bead of the first example body 12, and which is utilized and removed in the same manner as described with respect to the first example device 10. Thus, it may be punctured for insertion of a plurality of tendrils, as well as for insertion of a fishing hook, whether the tendrils and fishing hook extend through separate passages or the same passage.

FIGS. 7A and 7B show perspective views of another alternative body 512 of an example repositionable removable fishing hook trailer device 510 for use on a fishing hook. The two figures show the body 512 may be formed, such as by extrusion, with a pre-formed central passage 516 that may be helpful for insertion of a portion of a plurality of tendrils, a portion of a fishing hook, or both. Forming such a body 512 by extrusion also may be a more cost effective way of forming a large quantity of the bodies 512, which could be cut into individual beads from an elongated extrusion. In this example, the body 512 also includes grooves 524 around the outer surface of the body 512, which may provide greater ease of gripping or handling the device 510. The device 510 may otherwise be used and removed in a similar manner to the foregoing other examples with respect to receiving a portion of a plurality of tendrils in a first passage and receiving a portion of a fishing hook in a second passage through the body 512. As noted, the first and second passages may be at any angle relative to each other, or may be the same passage. The presentation of such a device 510 on a fishing hook may depend on the location along and rotational position relative to the fishing hook, and the direction which the tendrils extend outward from the body 512.

From the above disclosure, it will be apparent that repositionable removable fishing hook trailer devices for use on fishing hooks that are constructed in accordance with this disclosure may include a number of structural aspects that provide numerous advantages. The example aspects of such devices shown herein may exhibit one or more of the above-referenced potential advantages, depending upon the specific design chosen.

It will be appreciated that a repositionable removable fishing hook trailer device for use on a fishing hook constructed in accordance with the present disclosure may be provided in various configurations. Any variety of suitable materials of construction, configurations, shapes and sizes for the components and methods of connecting the components may be utilized to meet the particular needs and requirements of an end user. It is to be understood that the invention is not to be limited to the disclosed example embodiments, but rather, is intended to cover various modifications and equivalent arrangements included within the spirit and scope of the appended claims. Thus, the description and drawings should be considered illustrative and not restrictive of the invention, which is limited only by the appended claims and their legal equivalents.

1. A repositionable removable fishing hook trailer device for use on a fishing hook, comprising:
a body;
the body further comprising a resilient elastomeric bead;
a plurality of tendrils having a portion received in a first passage through the body and at least one portion extending outward from the body;
the body further configured to receive a portion of a fishing hook within a second passage through the body.

2. The repositionable removable fishing hook trailer device in accordance with claim 1, wherein two portions of the plurality of tendrils extend outward from opposite sides of the body.

3. The repositionable removable fishing hook trailer device in accordance with claim 1, wherein the resilient elastomeric material of the body further comprises silicone.

4. The repositionable removable fishing hook trailer device in accordance with claim 1, wherein the resilient elastomeric material of the body further comprises rubber.

5. The repositionable removable fishing hook trailer device in accordance with claim 1, wherein the body initially is solid and the first passage through the body that receives the portion of the plurality of tendrils is formed when the tendrils are forced through the body.

6. The repositionable removable fishing hook trailer device in accordance with claim 1, wherein the first passage through the body that receives the portion of the plurality of tendrils is pre-formed in the body prior to the body receiving the portion of the plurality of tendrils.

7. The repositionable removable fishing hook trailer device in accordance with claim 1, wherein the first passage through the body that receives the portion of the plurality of tendrils grips and maintains the position of the portion of the plurality of tendrils.

8. The repositionable removable fishing hook trailer device in accordance with claim 1, wherein the body initially is solid and the second passage through the body that receives the portion of the fishing hook is formed when a point of the fishing hook is forced through the body.

9. The repositionable removable fishing hook trailer device in accordance with claim 1, wherein the second passage through the body that receives the portion of the fishing hook is pre-formed in the body prior to the body receiving the portion of the fishing hook.

10. The repositionable removable fishing hook trailer device in accordance with claim 1, wherein the second passage through the body that receives the portion of the fishing hook grips and maintains the position of the body on the portion of the fishing hook.

11. The repositionable removable fishing hook trailer device in accordance with claim 1, wherein the body may be repositioned relative to the portion of the fishing hook along the length of the fishing hook.

12. The repositionable removable fishing hook trailer device in accordance with claim 1, wherein the body may be repositioned rotationally relative to the portion of the fishing hook.

13. The repositionable removable fishing hook trailer device in accordance with claim 1, wherein the first passage that receives the portion of the plurality of tendrils is the same passage as the second passage that receives a portion of the fishing hook.

14. The repositionable removable fishing hook trailer device in accordance with claim 1, wherein the first passage that receives the portion of the plurality of tendrils is at an angle relative to the second passage that receives a portion of the fishing hook.

15. The repositionable removable fishing hook trailer device in accordance with claim 14, wherein the first passage that receives the portion of the plurality of tendrils is perpendicular to the second passage that receives a portion of the fishing hook.

16. The repositionable removable fishing hook trailer device in accordance with claim 1, wherein the tendrils are constructed of a naturally occurring or synthetic material.

17. The repositionable removable fishing hook trailer device in accordance with claim 1, wherein the tendrils are constructed of silk.

18. The repositionable removable fishing hook trailer device in accordance with claim 17, wherein the tendrils are constructed of 100 weight pure filament silk thread.

19. The repositionable removable fishing hook trailer device in accordance with claim 1, wherein the tendrils are constructed of a material that absorbs water.

20. The repositionable removable fishing hook trailer device in accordance with claim 19, wherein the tendrils move in water with the flow of the water.
